(19) United States
(12) Patent Application Publication
(10) Pub. No.: US 2011/0317096 A1
(43) Pub. Date: Dec. 29, 2011

(54) PLANAR LIGHTING DEVICE AND LIQUID-CRYSTAL DISPLAY DEVICE WITH THE SAME

(76) Inventors: Masahiro Yokota, Fukaya-shi (JP); Ken Takahashi, Kumagaya-shi (JP); Osamu Ono, Fukaya-shi (JP); Hidemi Matsuda, Toda-shi (JP); Toshitake Kitagawa, Yokohama-shi (JP); Takashi Nishimura, Fukaya-shi (JP)

(21) Appl. No.: 13/226,235

(22) Filed: Sep. 6, 2011

Related U.S. Application Data
(63) Continuation of application No. PCT/JP2010/057370, filed on Apr. 26, 2010.

(30) Foreign Application Priority Data
Apr. 27, 2009 (JP) 2009-107926
Sep. 15, 2009 (JP) 2009-212619

(51) Int. Cl. G02F 1/13357; F21V 7/00

(52) U.S. Cl. 349/64; 362/235

(57) ABSTRACT

According to one embodiment, a planar lighting device includes a plurality of light sources, a light guide layer provided on a light-emission side of the light sources and configured to guide light from the light sources, and a reflective layer provided on an opposite side of the light guide layer to the light sources and through which a part of the light is transmitted. The light guide layer includes light-scattering properties for scattering light and is formed so that optical transmittance T based on the light-scattering properties is 40%≦T≦93%.

### CROSS-REFERENCE TO RELATED APPLICATIONS

This application is a Continuation Application of PCT Application No. PCT/JP2010/057370, filed Apr. 26, 2010 and based upon and claiming the benefit of priority from prior Japanese Patent Applications No. 2009-107926, filed Apr. 27, 2009; and No. 2009-212619, filed Sep. 15, 2009, the entire contents of all of which are incorporated herein by reference.

### FIELD

Embodiments described herein relate generally to a planar lighting device, comprising light sources and a light guide plate and configured to emit light through a flat or curved surface, and a liquid-crystal display device using the same.

### BACKGROUND

A planar lighting device is a device in which light emitted from light sources is radiated from a planar radiation surface. The planar lighting device of this type is not only used as a lighting device by itself but is combined with a liquid-crystal display panel to form a liquid-crystal display device.

Nowadays, there is a strong tendency to substitute light-emitting diodes (LEDs) for cathode-ray tubes, which have conventionally been used as common light sources of planar lighting devices, in view of the disuse of mercury. Since these LEDs are point light sources, a planar lighting device using them must comprise a mechanism for converting the point light sources into plane light sources. Thus, prior art techniques require increased device thickness and fail to achieve required performance levels. The following is a description of the prior art and problems of a specific planar lighting device for use as a backlight unit of a liquid-crystal display device.

Usually, a liquid-crystal display device comprises a liquid-crystal display panel and a backlight unit that illuminates the liquid-crystal display panel. Large commonly-used liquid-crystal display devices use a direct-type backlight in which light sources are arranged just below the screen. In contrast, medium or small commonly-used liquid-crystal display devices use a side-type backlight in which light sources are arranged on the screen side so that light is guided to the entire screen by a light guide plate.

In recent years, there have been increasing demands for backlight units used in large liquid-crystal display devices, in particular, to ensure high image quality, energy conservation, and thinness.

For example, a local dimming technology as a technology that ensures high image quality and energy conservation is proposed. According to this technology, light-emitting diodes (LEDs) are substituted for cold-cathode fluorescent lamps (CCFLs) as light sources of a backlight such that the individual light sources can be dimmed.

This is a drive system in which LED light sources that constitute a backlight unit are each divided into a plurality of regions such that necessary minimum luminance for a display image is given for each region. By means of this drive system, a black display image can be freed from black degradation due to backlight leakage, thereby achieving high image quality, and energy consumption by the LED light sources can be suppressed.

Although a side-type backlight unit is suitable for thickness reduction, it cannot deal with the local dimming technology, and hence, cannot achieve high image quality and energy conservation. As a means for solving this problem, a backlight unit is proposed such that a large number of small side-type light source units are arranged in a matrix. However, this unit has a problem that joints are inevitably conspicuous at regional boundaries.

On the other hand, a direct-type backlight that uses LED light sources can deal with the local dimming technology. To uniformly spread light emitted from the point light sources onto a diffusion plate, however, a sufficient space must be secured between the diffusion plate and light sources. Thus, thickness reduction is difficult.

A prior art technique to solve this problem is proposed such that each of spot light sources is enclosed with a reflective film and converted into a plane light source with uniform luminance by means of an upper transmission-reflection film, and that the light sources are arranged to form a planar lighting device.

Since the individual light sources are highly independent of one another, however, the planar lighting device of this type has some problems. First, if the planar lighting device is used as a backlight of a liquid-crystal display device of the local dimming drive type, changes in luminance can inevitably be clearly recognized by the viewer at the boundaries between light sources that are varied in dimming gradation. This is attributable to sudden changes in luminance at reflective sidewall portions. To obscure the unevenness at the boundaries, a profile is essential such that light leaks out into gentle adjacent regions and is attenuated there. Secondly, the LED light sources have their respective variations in chromaticity and luminance. In the planar lighting device that is lit by uniform energy throughout the entire surface, therefore, sudden changes in chromaticity or luminance at the boundaries between the light sources can inevitably be recognized by the viewer. Accordingly, the chromaticity and luminance of each LED must be defined by strict specifications for selection, thus entailing an increase in manufacturing costs. To avoid this, it is necessary to smooth fluctuations in chromaticity and luminance at the boundaries due to natural leakage to the adjacent regions.

If the point light sources such as LED light sources are used, as described above, there is a problem that the planar lighting device becomes thicker. In the liquid-crystal display device that achieves high image quality and energy conservation by means of the local dimming technology, moreover, restrictions on the planar lighting device used make it difficult to reconcile thinness with high image quality and energy conservation.

If the point light sources such as LED light sources are used, as described above, there is a problem that the planar lighting device becomes thicker. In the liquid-crystal display device that achieves high image quality and energy conservation by means of the local dimming technology, moreover, restrictions on the planar lighting device used make it difficult to reconcile thinness with high image quality and energy conservation.

### BRIEF DESCRIPTION OF THE DRAWINGS

FIG. 1 is an exploded perspective view showing a liquid-crystal display device with a planar lighting device according to a first embodiment;

FIG. 2 is a sectional view of the liquid-crystal display device;

FIG. 3 is a plan view showing a part of a reflective sheet of the planar lighting device of the liquid-crystal display device according to the first embodiment;

FIG. 4 is a diagram showing the relationship between the transmittance of a light guide layer and relative luminance;

FIG. 5 is a diagram showing the relationship between the transmittance of the light guide layer and efficiency;

FIG. 6A is a view illustrating an improvement in efficiency achieved when the light guide layer has light-scattering properties;

FIG. 6B is a view illustrating an improvement in efficiency achieved when the light guide layer has light-scattering properties;

FIG. 7A is a sectional view of the planar lighting device showing the positional relationship between the light guide layer and an LED;

FIG. 7B is a sectional view of the planar lighting device showing the positional relationship between the light guide layer and LED;

FIG. 8A is a sectional view of the planar lighting device with no optical connecting member between the light guide layer and LED;

FIG. 8B is a sectional view of the planar lighting device with an optical connecting member between the light guide layer and LED;

FIG. 9 is a sectional view showing a liquid-crystal display device according to a second embodiment;

FIG. 10 is a plan view showing a part of a reflective sheet of a planar lighting device of the liquid-crystal display device according to the second embodiment;

FIG. 11 is a sectional view showing a liquid-crystal display device according to a third embodiment;

FIG. 12 is a sectional view showing a liquid-crystal display device according to a fourth embodiment; and

FIG. 13 is a plan view schematically showing a light source arrangement of a planar lighting device according to another embodiment.

### DETAILED DESCRIPTION

Various embodiments will be described hereinafter with reference to the accompanying drawings.

In general, according to one embodiment, a planar lighting device comprises: a plurality of light sources, a light guide layer provided on a light-emission side of the light sources and configured to guide light from the light sources, and a reflective layer provided on an opposite side of the light guide layer to the light sources and through which a part of the light is transmitted, the light guide layer comprising light-scattering properties for scattering light and formed so that optical transmittance T based on the light-scattering properties is 40%≦T≦93%.

Liquid-crystal display devices with planar lighting devices according to embodiments will now be described in detail with reference to the drawings.

Although the planar lighting devices are described as being backlight units of the liquid crystal display devices in connection with the embodiments, the planar lighting devices alone may also be used as lighting devices. Since the planar lighting devices of the embodiments share a common configuration, only their configurations as liquid-crystal display devices will be described in connection with the embodiments, and a description thereof as lighting devices will be omitted.

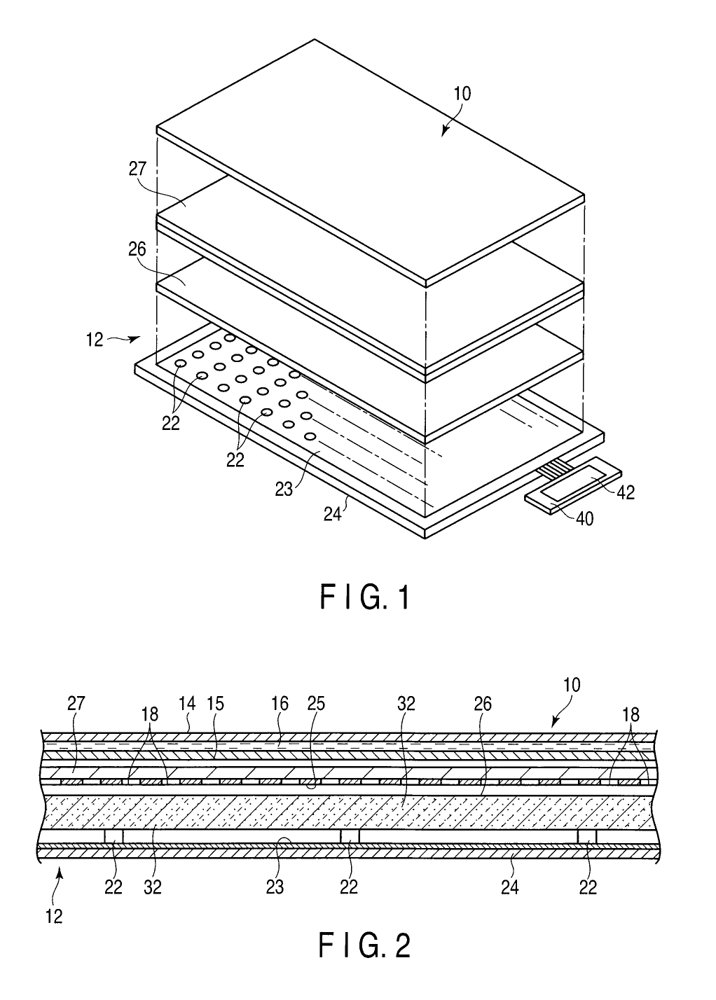

FIG. 1 is an exploded perspective view showing a liquid-crystal display device with a planar lighting device according to a first embodiment, and FIG. 2 is a sectional view of the liquid-crystal display device.

As shown in FIGS. 1 and 2, the liquid-crystal display device comprises a rectangular liquid-crystal display panel 10 and a planar lighting device 12 opposed to the rear surface side of the liquid-crystal display panel 10. The liquid-crystal display panel 10 comprises a rectangular array substrate 15, rectangular opposite substrate 14 opposed to the array substrate 15 with a gap therebetween, and liquid-crystal layer 16 sealed between the array substrate 15 and opposite substrate 14. The planar lighting device 12 is opposed adjacent to the array substrate 15 of the liquid-crystal display panel 10.

The planar lighting device 12 comprises a rectangular circuit board 24, lower-surface reflective layer 23, a large number of LEDs 22, rectangular light guide layer 26, light-diffusion layer 27, and upper reflective layer 25. The lower-surface reflective layer 23 diffusely reflects light incident on the upper surface of the circuit board 24. The LEDs 22 are arranged above the circuit board 24 with the lower-surface reflective layer 23 therebetween. The light guide layer 26 is disposed above the LEDs 22 and opposed to the lower-surface reflective layer 23. The light-diffusion layer 27 is interposed between the light guide layer 26 and liquid-crystal display panel 10. The upper reflective layer 25 is interposed between the light guide layer 26 and light-diffusion layer 27. The lower-surface reflective layer 23, upper reflective layer 25, light guide layer 26, and light-diffusion layer 27 are formed in substantially the same size as the liquid-crystal display panel 10 and are supported by a supporting member (not shown).

A large number of the LEDs 22, which function individually as point light sources, are mounted in a grid on the circuit board 24, electrically connected to the circuit board 24, disposed in contact with the lower surface of the light guide layer 26, and optically connected to the light guide layer 26.

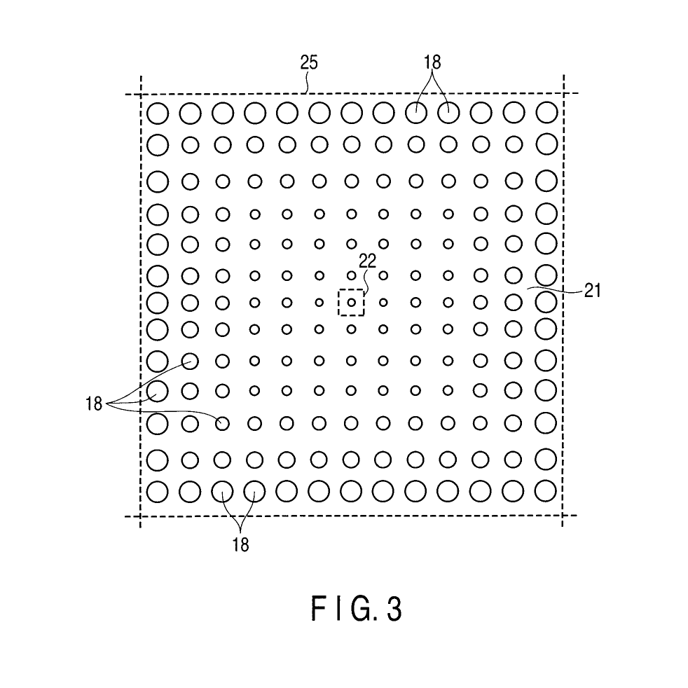

The upper reflective layer 25 is disposed on the surface of the light-diffusion layer 27 on the light guide layer 26 side. As shown in FIG. 3, the upper reflective layer 25 comprises light-transmission apertures 18 through which light is partially transmitted and a reflective region 21 that partially reflects light, and is formed so that the ratio of optical transmission in the portions (central portions) above the LEDs 22 are lower than in the portions (end portions) far from the LEDs 22. In other words, the aperture diameters of the light-transmission apertures 18 in the upper reflective layer 25 are smaller in the portions (central portions) above the LEDs 22 than in the portions (end portions) far from the LEDs 22. Thus, the upper reflective layer 25 is adjusted so that it can strongly reflect intense light in the portions (central portions) above the LEDs 22, thereby providing uniformity of luminance of the planar lighting device 12 as a whole.

As described above, the transmittance of the upper reflective layer 25 must be controlled by means of the light-transmission apertures 18. To this end, the reflectance of the reflective region 21 should be increased to some degree. In the present embodiment, the reflectance of the reflective region 21 is adjusted to 80% at the least, preferably to 90% or more. Likewise, a loss occurs if the reflective region 21 absorbs much light. While the optical absorption is assumed to be about 2% in the present embodiment, the light-use efficiency can be further increased if a material that absorbs less light is used.

The upper reflective layer 25 may be formed on the surface of the light guide layer 26 on the liquid-crystal display panel 10 side.

As shown in FIG. 2, the light guide layer 26 comprises a base material of a transparent resin and light-scattering particles 32 of a material different in refractive index from the base material, dispersed in the base material. A large number of concavo-convex portions (not shown) are formed uniformly or non-uniformly on the whole or partial surface of the light guide layer 26. Most of light emitted from the LEDs 22 and incident on the light guide layer 26 is moderately reflected and scattered by the light-scattering particles 32, widely propagated in the light guide layer 26, and emitted to the front through the light-transmission apertures 18 of the upper reflective layer 25, while maintaining the uniformity of luminance of the planar lighting device 12.

The density of the light-scattering particles 32 is controlled so that optical transmittance T of the light guide layer 26 with respect to its thickness is 40%≦T≦93%. In this case, transmittance T, which is obtained by a measurement method conforming with Japanese Industrial Standard K 7361, is the ratio of light that emerges on the front side of the light guide layer to light perpendicularly incident on the reverse side.

The following is a description of the basis on which transmittance T of the light guide layer 26 is prescribed.

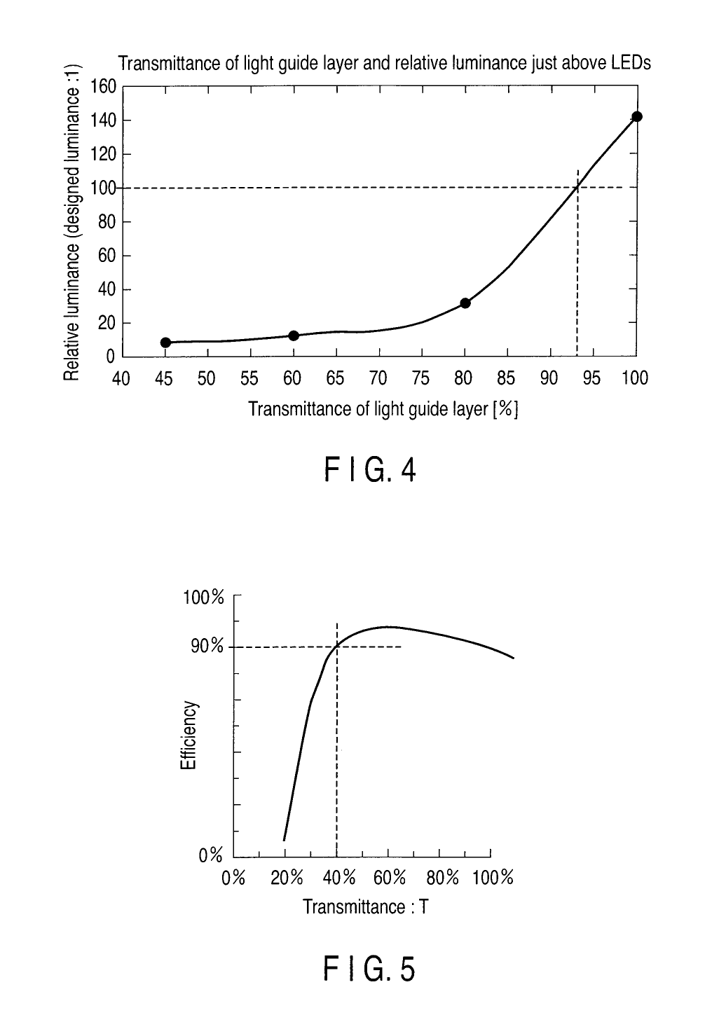

In FIG. 4, the abscissa represents the transmittance of the light guide layer 26 with a fixed thickness of 2 mm, and the ordinate represents the relative luminance on the LEDs 22 relative to the set transmittance of the planar lighting device 12 without the use of the upper reflective layer 25. The transmittance of a transparent light guide plate (2 mm) that is conventionally used is approximately 100%, and the relative luminance easily exceeds 100 times. Thus, in a conventional direct backlight that does not use the upper reflective layer 25, the light guide layer (assumed to be a hollow space) is enlarged to adjust the relative luminance to 1. In this case, the backlight is inevitably very thick, requiring a thickness not less than the LED array pitch. This relative luminance can be reduced by increasing the density of the light-scattering particles 32 and scattering light that travels straight up from the LEDs 22. The transmittance of the light guide layer 26 is given by this index.

On the other hand, in the case where the thickness of the light guide layer is adjusted to 2 mm to achieve uniform luminance, as shown in FIG. 4, compensation is made to adjust the above-described relative luminance to 1 by setting the optical transmittance of the upper reflective layer 25. Practically, however, such compensation as to make the relative luminance exceed 100 cannot be achieved, so that the luminance remains non-uniform. Thus, in order to enhance the compensation effect of the upper reflective layer 25, the diameter of the light-transmission apertures 18 above the LEDs 22 must first be reduced. In a printing process with high mass-productivity, however, it is difficult to achieve an aperture resolution of 80 μm or less. If a solid film is used, moreover, some light can be transmitted through a solid reflective film in the phase of print formation. Secondly, in order to enhance the compensation effect, the array pitch of the light-transmission apertures 18 must be increased. If it is a coarse pitch more than 0.8 mm, however, the pattern of the light-transmission apertures 18 is inevitably recognized by the viewer. For these reasons, compensation by means of the upper reflective layer 25 is difficult in a region where the relative luminance exceeds 100. Thus, the transmittance of the light guide layer 26 is restricted to 93% or less such that the uniformity of luminance of the planar lighting device can be compensated for.

In FIG. 5, the abscissa represents the transmittance of the light guide layer 26, and the ordinate represents the light-use efficiency calculated by an optical analysis. Here the light-use efficiency is the ratio of light that reaches the front of the planar lighting device 12 to light emitted from the LEDs 22. If transmittance T of the light guide layer 26 is reduced, the average free stroke of light becomes shorter, and the light emitted from the LEDs 22 and projected on the light guide layer 26 is immediately reflected and scattered so that more light returns to the LEDs 22. In an optical transmission path of the planar lighting device 12, the coefficient of optical absorption in the LEDs is the highest, and the light-use efficiency is reduced, resulting in degradation in luminance, as the light that returns to the LEDs increases. A design loss suddenly increases if the average free stroke of light-scattering is less than 0.05 mm. A light-use efficiency of 90%, a threshold, is set as a tolerance, and hence, the transmittance of the light guide layer 26 is 40% or more.

In the range of transmittance of 60 to 100%, as shown in FIG. 5, the lower the transmittance, the more the efficiency is improved. This is because the lower the transmittance, the lower the relative luminance in a region just above the LEDs shown in FIG. 4 can be, so that losses of reflection and absorption of the upper and lower reflective layers 25 and 23 are improved by increasing the average transmittance of the upper reflective layer 25.

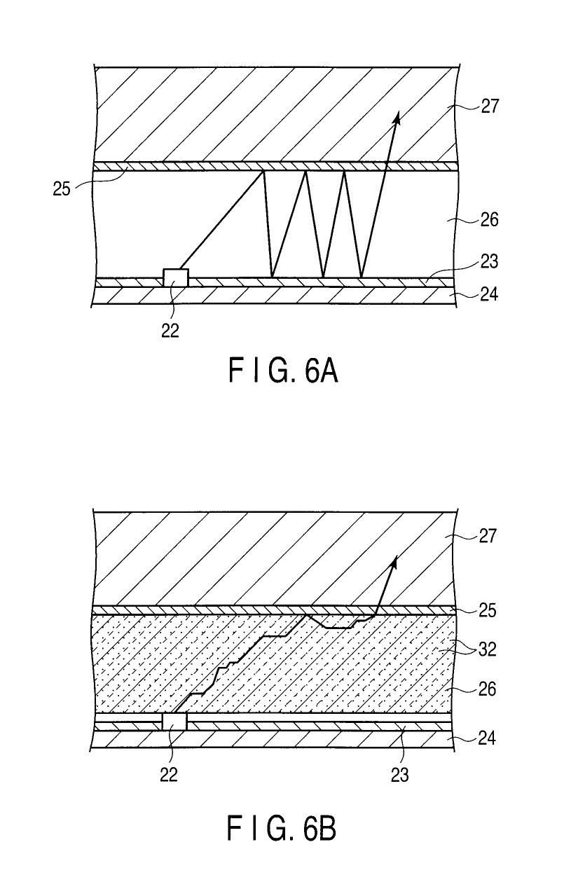

FIGS. 6A and 6B are views illustrating improvements in efficiency due to the light-scattering properties. If the light guide layer 26 is air or a transparent medium, as shown in FIG. 6A, light emitted from the LEDs 22 repeats reflection between the upper reflective layer 25 and lower reflective layer 23 and is soon emitted forward through the upper reflective layer 25. As this is done, each cycle of reflection involves an absorption loss of about 2%, so that the higher the frequency of reflection, the lower the efficiency is. In the transparent light guide layer 26, the light just above the LEDs 22 is intense, as shown in FIG. 4, so that the transmittance of the upper reflective layer 25 is minimized. Consequently, the frequency of reflection increases, so that the efficiency is reduced.

If the transmittance of the light guide layer 26 is reduced by means of the light-scattering particles 32 and the like, as shown in FIG. 6B, the light emitted from the LEDs 22 is scattered and spread in the light guide layer. Then, the average transmittance of the upper reflective layer is increased to compensate for the attenuation of the light just above the LEDs 22, as shown in FIG. 4. Consequently, the frequency of reflection can be reduced to improve the efficiency. If the transmittance of the light guide layer 26 is regulated, an improvement of the light-use efficiency of the planar lighting device, as well as a reduction in burden on the upper reflective layer, can be achieved.

Although optical transmittance T is controlled by the density of the light-scattering particles 32 according to the present embodiment, this arrangement is not particularly essential. In general, transmittance T of the light guide layer 26 in which the light-scattering particles 32 are dispersed is determined depending on the average free stroke and scattering angle distribution of light. Further, the average free stroke and scattering angle distribution are determined depending on the refractive index, particle diameter, and concentration of the light-scattering particles 32. Thus, transmittance T of the light guide layer 26 can be easily controlled to the same effect by combining the particle diameter, refractive index, etc., as well as the density. It is important, moreover, to optimally set transmittance T of the light guide layer 26, and the light-scattering particles 32 need not always be particles with different refractive indices and may be replaced with refractive-index interfaces of small air bubbles or protrusions and indentations.

As shown in FIG. 1, the planar lighting device 12 comprises a control unit 40 for controlling the LEDs 22. The control unit 40 is connected to a main control unit (not shown) of the liquid-crystal display device, as well as to the circuit board 24. The control unit 40 comprises a light emission regulation unit 42, which adjusts the quantity of light emission for each LED 22 or each unit comprising a plurality of adjacent LEDs 22, based on a video luminance signal delivered from the main control unit of the liquid-crystal display device. Thus, the control unit 40 dims the planar lighting device 12 in accordance with video data by individually driving the LEDs 22.

In the planar lighting device 12 constructed in this manner, the light emitted from the LEDs 22 lands on the light guide layer 26 when the LEDs 22 are turned on. After the light is scattered and propagated in the light guide layer 26, a part of it is emitted from the upper reflective layer 25, further diffused by the light-diffusion layer 27, and then applied to the liquid-crystal display panel 10. The remaining light repeats reflection, scattering, and propagation mainly between the lower surface of the light guide layer 26 and the upper reflective layer 25, and is then emitted through the upper reflective layer 25 and further applied to the liquid-crystal display panel 10 through the light-diffusion layer 27.

According to the planar lighting device 12 constructed in this manner, the LEDs 22, light guide layer 26 disposed on the LEDs 22, light-diffusion layer 27, and upper reflective layer 25 formed on the lower surface of the light-diffusion layer 27 are superposed basically without spaces therebetween. Therefore, the device 12 can be made thinner than a conventional direct planar lighting device. Normally, in the planar lighting device 12, the quantity of light emitted from the LEDs 22 is large in the portions (central portions) above the LEDs 22, so that the luminance of these regions is inevitably high. In the planar lighting device 12 constructed in this manner, however, a part of the light emitted from the LEDs 22 is laterally reflected by the light-scattering particles 32 and upper reflective layer 25, propagated in the light guide layer 26, and then emitted from the upper reflective layer 25. Thus, the luminance just above the LEDs 22 can be reduced to achieve a uniform luminance distribution throughout the entire surface of the planar lighting device 12.

A plurality of protrusions (not shown) that diffusely reflects light are formed on the lower surface of the light guide layer 26, and the lower-surface reflective layer 23 is formed as a reflective film that diffusely reflects light. Therefore, the optical angle changes so that optical directions are mixed in these portions. Accordingly, the luminous intensity distribution of light incident on the light guide layer 26 is an extensive distribution. Thus, the planar lighting device 12 can obtain uniform luminance properties without unevenness in luminance with respect to all directions.

In the planar lighting device 12, the same luminance distribution can be obtained for the individual LEDs 22, so that local dimming drive can be achieved. For a drive area unit, each LED 22 may be partially driven or each unit comprising a plurality of adjacent LEDs 22 may be partially driven. This alternative method should only be suitably selected depending on the screen size, compatibility with a driver circuit, etc.

Further, the spread of a luminance profile of each LED can be controlled by changing the transmittance of the light guide layer 26. Thus, a desired luminance profile can be designed, so that more appropriate design flexibility can be achieved for improvement in image quality.

Since the light guide layer 26 is formed covering the entire surface without discontinuity, moreover, light also gently leaks into adjacent regions and is attenuated at the boundaries between the units driven by local dimming. The degree of this attenuation can also be design-controlled by setting the transmittance. Thus, unevenness at the boundaries can be obscured.

Accordingly, there may be obtained a planar lighting device that can reconcile thinness with energy conservation and a high contrast ratio and is excellent in uniformity of luminance in the light-emitting regions in the local dimming drive. If this planar lighting device is applied to a liquid-crystal display device, a large-screen liquid-crystal display device of high quality can be provided that achieves high contrast, low energy consumption, and thinness.

While the planar lighting device for use as a liquid-crystal display device has been described in connection with the present embodiment, it may also be used as a planar lighting device itself for lighting use or the like.

In the present embodiment, the protrusions and indentations on the interfaces of the light guide layer 26 are spherical. Since they are provided for the purpose of changing the direction of reflection of light, however, their shapes and directions of projection are not restricted, and they may each be in the form of a cone, pyramid, or recess, for example. Further, the protrusions and indentations may be composite concavo-convex portions or be arranged non-uniformly. Their shapes or arrangement should only be suitably selected depending on the workability, degree of diffusion of light, etc.

The upper reflective layer 25 may be either a specular reflective surface or a diffuse reflective surface. In the case of a diffuse reflective surface, the effect of propagation of light is less and the uniformity of luminance is slightly lower than in the case of specular reflection. However, optical absorption is lower than that of a specular reflective film. The type of reflection of the upper reflective layer 25 should only be suitably selected depending on the product application or the like. Although the upper reflective layer 25 is formed on the lower surface of the light-diffusion layer 27, moreover, the invention is not particularly limited to this configuration, and the upper reflective layer 25 may alternatively be formed on the upper surface of the light guide layer 26.

Although the LEDs 22 and light guide layer 26 are optically coupled to one another in the present embodiment, the invention is not particularly limited to this configuration. The LEDs 22 and light guide layer 26 may alternatively be optically isolated from one another. In this case, the planar lighting device can be easily assembled and is configured to be adaptive to relatively small general-purpose products. Whether to optically couple or isolate the LEDs 22 and light guide layer 26 should only be suitably selected depending on the product application or the like.

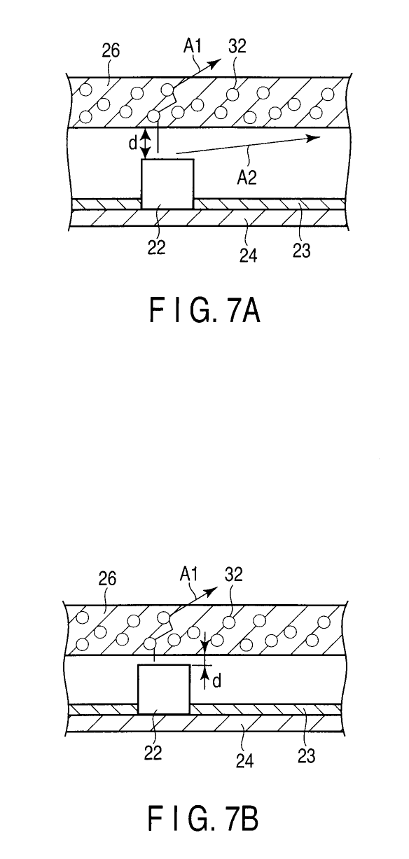

In the case where the LEDs 22 and light guide layer 26 are optically isolated from one another, a gap between the LEDs 22 and light guide layer 26 is preferably adjusted to 2 mm or less. This is done because if gap d is too large, as shown in FIG. 7A, the quantity of light emitted at a low angle from the LEDs 22 inevitably becomes so large that some of light beams to be incident on the light guide layer 26 in the manner indicated by arrow A1 are propagated a long distance as indicated by arrow A2. Thereupon, the luminance in non-lit regions is increased so that the contrast is reduced at the time of local dimming control. To suppress this effect, gap d between the LEDs 22 and light guide layer 26 is preferably restricted to 2 mm or less, as shown in FIG. 7B.

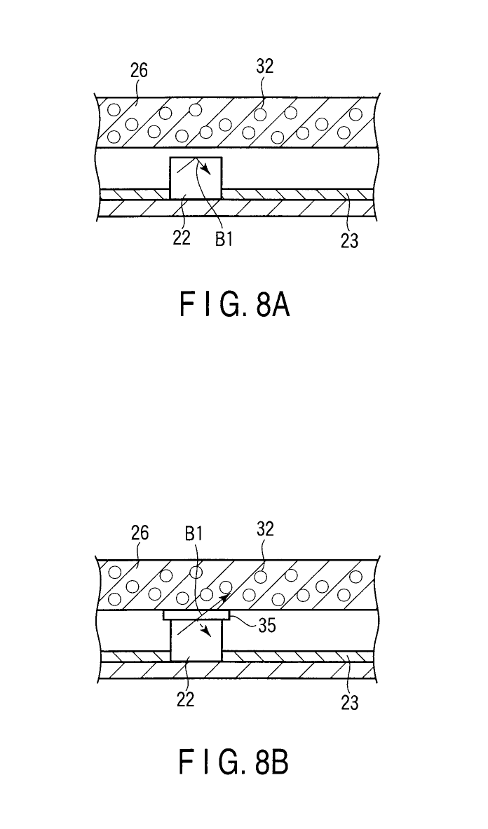

Further, if there is a gap between the LEDs 22 and light guide layer 26, as shown in FIG. 8A, some of light beams from the LEDs 22 are totally reflected by air interfaces of the LEDs 22, as indicated by arrow B1. Thereupon, a loss of absorption in the LEDs 22 increases so that the quantity of emitted light is reduced. As shown in FIG. 8B, therefore, the LEDs 22 and light guide layer 26 are optically connected by means of an optical connecting member 35, the refractive index of which is similar to that of the LEDs 22. In this way, the total reflection by the air interfaces of the LEDs 22 is reduced, so that the quantity of light absorbed in the LEDs 22 is suppressed. Thus, the luminance is improved by about 10%. In the present embodiment, the LEDs 22 and light guide layer 26 are basically laminated, so that the light-use efficiency can be easily improved by the optical connection.

The following is a description of planar lighting devices according to alternative embodiments.

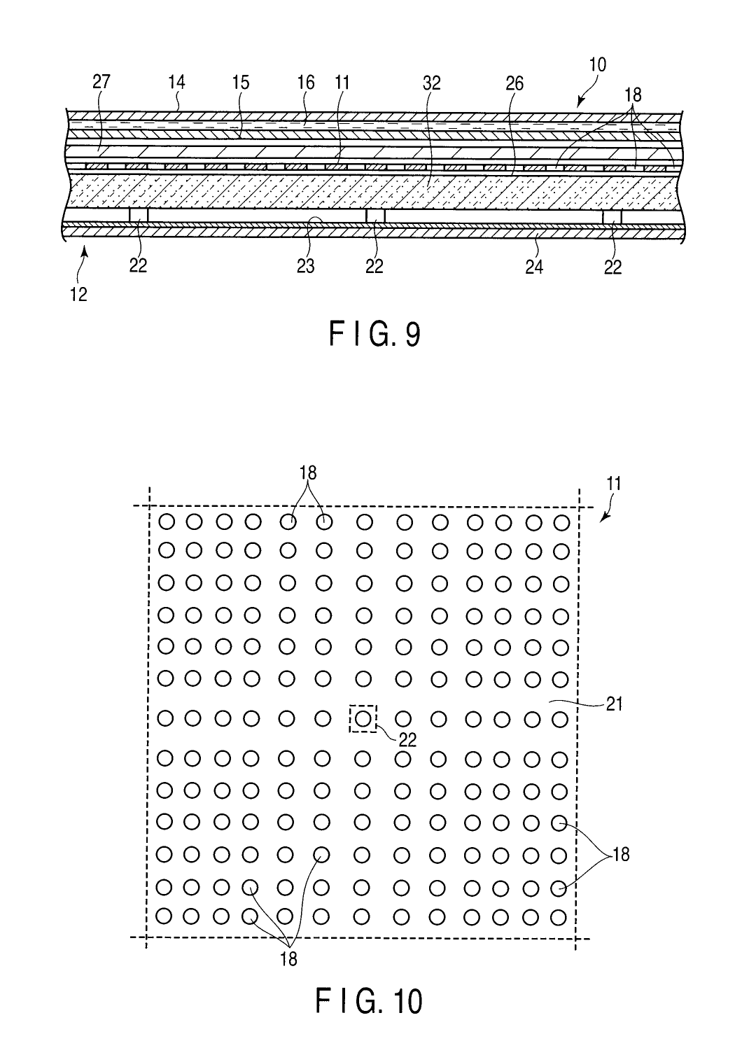

FIG. 9 is a sectional view showing a liquid-crystal display device according to a second embodiment.

According to the second embodiment, an independent reflective sheet is produced as an upper reflective layer 11 between light guide layer 26 and light-diffusion layer 27. Since other configurations of the liquid-crystal display device are the same as those of the foregoing first embodiment, like reference numbers are used to designate like portions, and a detailed description thereof is omitted.

FIG. 10 is a partially enlarged plan view of the upper reflective layer 11. The upper reflective layer 11 is formed with a large number of circular light-transmission apertures 18 through which light is transmitted. Further, a reflective film 21 is formed on the surface of the upper reflective layer 11 on the light guide layer 26 side. Thus, in the upper reflective layer 11, the light-transmission apertures 18 form transmission regions through which light is transmitted, while the other part forms a reflective region that specularly reflects light.

As shown in FIG. 10, the upper reflective layer 11 is formed so that the rate of optical transmission through the portions (central portions) above LEDs 22 is lower than that through the portions far from the LEDs 22. Thus, in the upper reflective layer 11, the distances between the light-transmission apertures 18 in the portions (central portions) above the LEDs 22 are larger than in the portions (end portions) far from the LEDs 22. In this case, the light-transmission apertures 18 have the same diameter. The array pitch of the light-transmission apertures 18 above the LEDs 22 is larger than in the portions far from the LEDs 22. Thus, in the upper reflective layer 11, the optical transmittance in the portions just above the LEDs 22 is reduced, so that non-uniformity of luminance of a planar lighting device 12 can be further improved. If the arrangement distances between the LEDs 22 are large, in particular, the uniformity of luminance cannot be easily controlled. However, the above-described structure serves as effective means for achieving uniform luminance.

According to the planar lighting device 12 constructed in this manner, as in the first embodiment, light having transmitted through the light guide layer 26 and upper reflective layer 11 can obtain a uniform luminance distribution throughout the entire surface. Further, the second embodiment can also provide the same functions and effects as those of the foregoing first embodiment.

It is to be understood that, according to the present embodiment, the type of reflection by the reflective film 21 is not particularly restricted and the invention is applicable to any of specular reflection, diffuse reflection, combination of these reflections, etc.

Although the optical transmittance of the upper reflective layer 11 is controlled based on the density of the pitch of the light-transmission apertures 18 in the second embodiment described above, the invention is not limited to this arrangement. The array pitch of the light-transmission apertures 18 may be fixed so that the transmittance of the upper reflective layer 11 can be controlled according to the aperture area based on the aperture diameter, aperture shape, etc. For example, the array pitch of the light-transmission apertures 18 may be fixed so that the diameters of the light-transmission apertures 18 in the central portions of light-emitting regions is smaller, and that the diameters of the light-transmission apertures 18 become larger as the end portions of the light-emitting regions is approached. Further, the same effect can be obtained if the pitch and aperture area of the light-transmission apertures 18 are combined for the control.

The light-transmission apertures 18 are not limited to being circular in shape and may be another shape, such as square or elliptical. In contrast, the reflective film 21 may be formed as circular or rectangular dots such that the remaining portion forms a light-transmission aperture 18. This alternative arrangement should only be suitably selected in consideration of the workability of the light-transmission apertures 18. In the embodiment described above, moreover, the optical transmittance of the upper reflective layer 11 is varied between the central portions and end portions of the light-emitting regions. If the arrangement interval between the LEDs 22 is short or if LEDs with a wide luminous intensity distribution angle are used, for example, light-transmission apertures of a uniform diameter may be arranged at a uniform pitch over the entire surface of the upper reflective layer 11. This arrangement should only be suitably selected depending on the interval between the LEDs 22, luminous intensity distribution, etc.

The following is a description of a liquid-crystal display device according to a third embodiment.

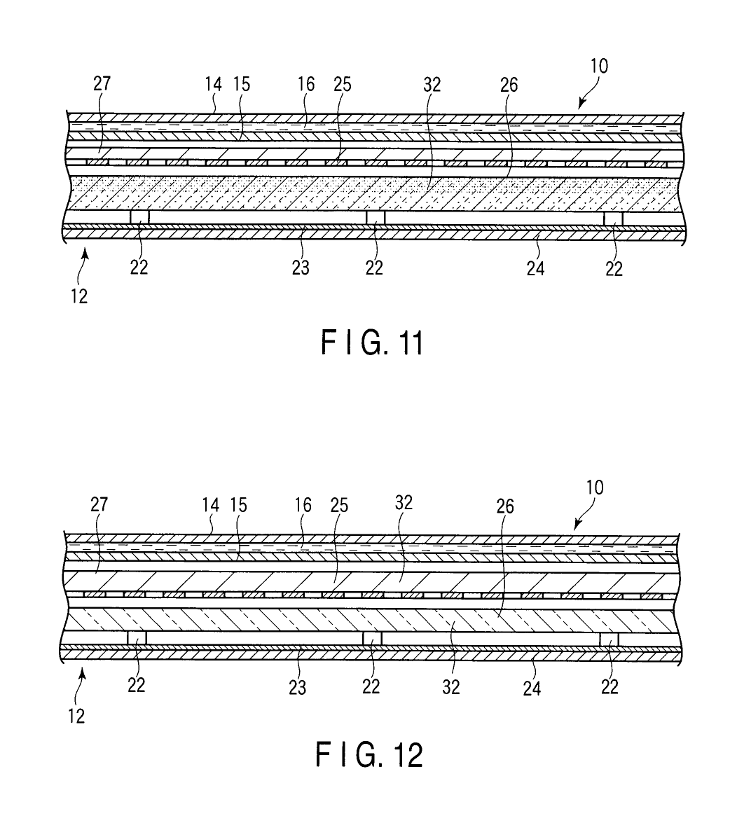

FIG. 11 is a sectional view showing the liquid-crystal display device according to the third embodiment.

According to the third embodiment, the density distribution of light-scattering particles 32 of a light guide layer 26 is higher on the side of a liquid-crystal display panel 10 than on the side of LEDs 22. Therefore, the optical transmittance of the light guide layer 26 is lower on the liquid-crystal display panel 10 side than on the LEDs 22 side. Since other configurations of the liquid-crystal display device of the third embodiment are the same as those of the foregoing first embodiment, like reference numbers are used to designate like portions, and a detailed description thereof is omitted.

As described before, the optical absorbance of the

LEDs 22 is high, and the light-use efficiency is inevitably reduced if light is applied again to the LEDs 22 by the light-scattering particles 32.

According to the third embodiment, the density of the light-scattering particles 32 near the surfaces of the LEDs 22 is low. Since the light is diffused after it is sufficiently spread to a certain degree, therefore, a loss due to the light applied again to the LEDs 22 can be considerably reduced. In the light guide layer 26, on the other hand, the density of the light-scattering particles 32 in the portions far from the LEDs 22 is so high that light can be diffused substantially uniformly into the light guide layer 26. Thus, uniformity of its luminance, along with that of an upper reflective layer 25, can be secured.

The following is a description of a planar lighting device according to a fourth embodiment.

FIG. 12 is a sectional view showing a liquid-crystal display device according to the fourth embodiment.

According to the present embodiment, a light-diffusion layer 27, like a light guide layer 26, is configured so that a large number of light-scattering particles 32 are dispersed therein. The density of light-scattering particles 32 of the light-diffusion layer 27 is higher than that of the light guide layer 26, that is, the optical transmittance of the light-diffusion layer 27 is lower than that of the light guide layer 26. Since other configurations of the planar lighting device 12 and liquid-crystal display device are the same as those of the foregoing first embodiment, like reference numbers are used to designate like portions, and a detailed description thereof is omitted.

According to the planar lighting device 12 constructed in this manner, as in the third embodiment, the density of the light-scattering particles 32 near the surfaces of LEDs 22 is low, while the density of the light-scattering particles 32 far from the surfaces of the LEDs 22 is high. Therefore, a loss of light on the surfaces of the LEDs 22 is so small that the light can be diffused efficiently. Further, the sixth embodiment can also provide the same functions and effects as those of the foregoing first and third embodiments.

Although the transmittance is controlled based on the difference in the density of the light-scattering particles 32 in the above-described embodiment, the invention is not limited to this. It is to be understood that the light guide layer 26 and light-diffusion layer 27 may be formed having the same density of the light-scattering particles so that the transmittance of the light-diffusion layer 27 can be reduced by making the light-diffusion layer 27 thicker than the light guide layer 26.

This invention is not limited directly to the embodiments described above, and at the stage of carrying out the invention, its constituent elements may be embodied in modified forms without departing from the spirit of the invention. Further, various inventions can be formed by appropriately combining the constituent elements disclosed in the above-described embodiments. For example, some constituent elements may be deleted from all the constituent elements shown in the embodiments. Furthermore, constituent elements of different embodiments may be combined as required.

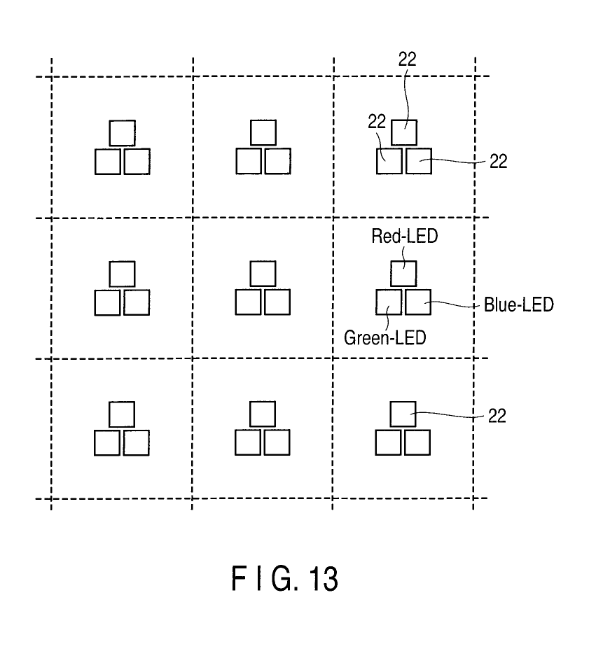

The LEDs 22 applicable as point light sources may be white or monochromatic ones, and there are no restrictions on the type of the LEDs 22. In the case where color display is performed using monochromatic LEDs, for example, a uniform luminance distribution free of color drift can be obtained by adjacently arranging each three LEDs 22 that individually emit red, blue, and green lights, as shown in FIG. 13. The light sources are not limited to point light sources and may be linear light sources, such as cold-cathode fluorescent lamps (CCFLs).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A planar lighting device comprising:
a plurality of light sources,
a light guide layer provided on a light-emission side of the light sources and configured to guide light from the light sources, and
a reflective layer provided on an opposite side of the light guide layer to the light sources and through which a part of the light is transmitted,
the light guide layer comprising light-scattering properties for scattering light and formed so that optical transmittance T based on the light-scattering properties is 40%≦T≦93%.

2. The planar lighting device of claim 1, wherein the reflective layer comprises a light-transmission region and a light-reflective region and the reflectance of the light-reflective region is 80% or more.

3. The planar lighting device of claim 1, wherein the light guide layer is formed so that the optical transmittance on the light-source side is higher than that on the opposite side to the light sources.

4. The planar lighting device of claim 1, further comprising a diffusion layer provided on the opposite side of the reflective layer to the light sources.

5. The planar lighting device of claim 4, wherein the transmittance of the diffusion layer is lower than that of the light guide layer.

6. The planar lighting device of claim 1, wherein the light-scattering properties are attributable to a material with a refractive index different from that of a base material of the light guide layer dispersed in the light guide layer or air bubbles dispersed in the light guide layer.

7. The planar lighting device of claim 1, wherein the optical transmittance of the reflective layer at a portion just above the light sources is lower than that of the other portion of the reflective layer.

8. The planar lighting device of claim 1, wherein a gap between upper surfaces of the light sources and a lower surface of the light guide layer is 2 mm wide or less.

9. The planar lighting device of claim 1, wherein the light sources are optically coupled to the light guide layer.

10. The planar lighting device of claim 1, further comprising a number of concavo-convex portions formed uniformly or non-uniformly on the whole or partial surface of the light guide layer.

11. The planar lighting device of claim 1, wherein the light sources are point light sources.

12. The planar lighting device of claim 1, further comprising a light emission regulation unit configured to partially adjust the quantity of light emission from the light sources for each light source or each unit comprising a plurality of adjacent light sources.

13. A liquid-crystal display device comprising:
a liquid-crystal display panel; and
the planar lighting device of claim 1 opposed to a rear surface of the liquid-crystal display panel and configured to apply light to the liquid-crystal display panel.

14. A liquid-crystal display device comprising:
a liquid-crystal display panel; and
the planar lighting device of claim 2 opposed to a rear surface of the liquid-crystal display panel and configured to apply light to the liquid-crystal display panel.
